(19) United States
(12) Patent Application Publication
(10) Pub. No.: US 2026/0039574 A1
(43) Pub. Date: Feb. 5, 2026

(54) Method and Apparatus for Service Management

(71) Applicant: Telefonaktiebolaget LM Ericsson (publ), Stockholm (SE)

(72) Inventors: Ping Chen, Shanghai (CN); Qiang Liu, Shanghai (CN); Susana Fernandez Alonso, Madrid (ES); Emiliano Merino Vazquez, Madrid (ES)

(21) Appl. No.: 19/099,098

(22) PCT Filed: Jul. 14, 2023
(86) PCT No.: PCT/CN2023/107405

§ 371 Date: Jan. 28, 2025

(30) Foreign Application Priority Data
Aug. 4, 2022 (WO) PCT/CN2022/110213

(51) Int. Cl. H04L 43/0817; H04L 69/322

(52) U.S. Cl. CPC H04L 43/0817; H04L 69/322

(57) ABSTRACT

Embodiments of the present disclosure provide methods and apparatuses for. A method performed by an exposure entity, comprising receiving a first parameter provisioning request from an application entity, wherein the first parameter provisioning request includes at least one Quality of Service. QoS reference parameter for at least one User Equipment, UE or UE group. The method further comprises determining at least one internal subscribed QoS parameter based on the at least one QoS reference parameter. The method further comprises sending a second parameter provisioning request to a data management entity, wherein the second parameter provisioning request includes the at least one internal subscribed QoS parameter.

### TECHNICAL FIELD

The non-limiting and exemplary embodiments of the present disclosure generally relate to the technical field of communications, and specifically to methods and apparatuses for service management.

### BACKGROUND

This section introduces aspects that may facilitate a better understanding of the disclosure. Accordingly, the statements of this section are to be read in this light and are not to be understood as admissions about what is in the prior art or what is not in the prior art.

FIG. 1 schematically shows a high level architecture in the next generation network such as 5G. The system architecture of FIG. 1 may comprise some exemplary elements such as UE (User Equipment), AMF (Access and mobility Function), SMF (Session Management Function), AUSF (Authentication Service Function), UDM (Unified Data Management), PCF (Policy Control Function), AF (Application Function), NSSF (Network Slice Selection Function), NEF (Network Exposure Function), UPF (User plane Function) and NRF (NF Repository Function), (R) AN ((Radio) Access Network), SCP (Service Communication Proxy), DN (Data Network), etc.

In accordance with an exemplary embodiment, the UE can establish a signaling connection with the AMF over the reference point N1, as illustrated in FIG. 1. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a packet data unit (PDU) session to the DN (data network, e.g. an operator network or Internet) through the UPF over the reference point N6.

As further illustrated in FIG. 1, the exemplary system architecture also contains the service-based interfaces such as Nnrf, Nnef, Nausf, Nudm, Npcf, Namf and Nsmf exhibited by NFs such as the NRF, the NEF, the AUSF, the UDM, the PCF, the AMF and the SMF. In addition, FIG. 1 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The Network Exposure Function (NEF) supports external exposure of capabilities of network functions. External exposure can be categorized as Monitoring capability, Provisioning capability, Policy/Charging capability, network status reporting capability and Analytics reporting capability. The Monitoring capability is for monitoring of specific event for UE in 5GS and making such monitoring events information available for external exposure via the NEF. The Provisioning capability is for allowing external party to provision of information which can be used for the UE in 5GS. The Policy/Charging capability is for handling QOS (Quality of Service) and charging policy for the UE based on the request from external party. The Analytics capability is for allowing external party to acquire analytics information generated by 5G System.

3GPP TS 23.502 V17.4.0 clause 4.15.6.6 discloses a solution that NEF exposes an API (Application Programming Interface) for AF session with QoS to upgrade the QoS, but this API requires an existing PDU session to be established first, and the QoS influence is only valid for the lifetime of the PDU session.

There is no mechanism to let AF influence on this QoS upgrade for the default QoS flow that applies to a group of users and work beyond the scope of an established PDU session, i.e., the only way to achieve this with current standards is to manually provision the subscribed QoS for each UE belonging to the group of UEs affected. For ongoing PDU sessions, the AF can influence the default QoS flow only for Multimedia Priority Services, and the prioritized Default QoS will be revoked when the service or the PDU session is terminated.

To overcome or mitigate at least one above mentioned problems or other problems or provide a useful solution, the embodiments of the present disclosure propose an improved context resume solution.

In a first aspect of the disclosure, there is provided a method implemented in an exposure entity. The method comprises: receiving a first parameter provisioning request from an application entity, the first parameter provisioning request includes at least one Quality of Service, QoS reference parameter for at least one User Equipment, UE or UE group. The method further comprises determining at least one internal subscribed QoS parameter based on the at least one QoS reference parameter. The method further comprises sending a second parameter provisioning request to a data management entity, wherein the second parameter provisioning request includes the at least one internal subscribed QoS parameter.

In an embodiment, the determining at least one internal subscribed QoS parameter further comprising: mapping the at least one QOS reference parameter to the at least one internal subscribed QoS parameter based on a mapping configuration.

In an embodiment, the first and the second parameter provisioning request further includes the following: an identifier of the application entity, and a UE identifier or an external group identifier. The method further comprises determining at least one Protocol Data Unit, PDU session in which the QoS reference parameter to be applied at least based on the identifier of the application entity.

In an embodiment, the internal subscribed QoS parameter comprises at least one of the following: 5G QoS Identifier (5Q1)/QoS Class Identifier (QCI); Allocation and Retention Priority, ARP; PriorityLevel.

In an embodiment, the exposure entity comprises a Network Exposure Function, NEF, or a Service Capability Exposure Function, SCEF; the application entity comprises an Application Function, AF, or a Service Capability Server (SCS)/Application Server (AS); the data management entity comprises a Unified Data Management, UDM, or a Home Subscriber Server, HSS.

In a second aspect of the disclosure, there is provided a method implemented in a network entity. The method comprises: receiving a second parameter provisioning request from an exposure entity, wherein the second parameter provisioning request includes the at least one internal subscribed QoS parameter. The method further comprises determining at least one applied QoS parameter based on the at least one internal subscribed QoS parameter, wherein the applied QoS parameter is to be applied to at least one User Equipment, UE or UE group. the method further comprises sending the applied QoS parameter to a session management entity.

In an embodiment, the second parameter provisioning request further includes the following: an identifier of the application entity, and a UE identifier or an external group identifier.

In an embodiment, the method further comprises determining whether the application entity is authorized to provision parameter for the UE based on the identifier of the application entity; if authorized, store the at least one internal subscribed QoS parameter.

In an embodiment, the method further comprises receiving a QoS parameter request from the session management entity.

In an embodiment, the method further comprises obtaining at least one original QoS parameter, wherein the at least one original QoS parameter is pre-configured for the at least one UE or UE group.

In an embodiment, the determining at least one applied QoS parameter further comprises: selecting one from the at least one internal subscribed QoS parameter and the at least one original QOS parameter as the applied QoS parameter.

In an embodiment, the determining at least one applied QoS parameter further comprises selecting the at least one internal subscribed QoS parameter as the applied QoS parameter.

In an embodiment, the determining at least one applied QoS parameter based on the at least one internal subscribed QoS parameter further comprises determining the at least one internal subscribed QoS parameter as the applied QoS parameter.

In an embodiment, the method further comprises checking whether there is at least one PDU session ongoing for the at least one UE; if yes, sending the applied QoS parameter to the session management entity, so that the at least one internal subscribed QoS parameter can take effect immediately.

In an embodiment, the internal subscribed QoS parameter comprises at least one of the following 5G QoS Identifier (5Q1)/QoS Class Identifier (QCI); Allocation and Retention Priority, ARP; PriorityLevel.

In an embodiment, the network entity comprises a Unified Data Management, UDM, or a Home Subscriber Server, HSS, or a Policy Control Function, PCF, or a Unified Data Repository, UDR; the exposure entity comprises a Network Exposure Function, NEF, or a Service Capability Exposure Function, SCEF; the application entity comprises an Application Function, AF, or a Service Capability Server (SCS)/Application Server (AS).

In a third aspect of the disclosure, there is provided a method implemented in an application entity. The method comprises obtaining at least one Quality of Service, QoS reference parameter for at least one User Equipment, UE. The method further comprises sending a first parameter provisioning request to an exposure entity, wherein the first parameter provisioning request includes the at least one QoS reference parameter.

In an embodiment, the method further comprises determining that the at least one QoS reference parameter for at least one UE or UE group needs to be changed.

In an embodiment, the first and the second parameter provisioning request further includes an identifier of the application entity and an external group identifier.

In an embodiment, the exposure entity comprises a Network Exposure Function, NEF, or a Service Capability Exposure Function, SCEF; the application entity comprises an Application Function, AF, or a Service Capability Server (SCS)/Application Server (AS).

In a fourth aspect of the disclosure, there is provided a method implemented in a policy control entity. The method comprises receiving a second parameter provisioning request from an exposure entity, wherein the second parameter provisioning request includes the at least one Quality of Service, QoS reference parameter; the method further comprises determining at least one internal subscribed QoS parameter based on the at least one QoS reference parameter; the method further comprises determining at least one applied QoS parameter based on the at least one internal subscribed QoS parameter, wherein the applied QoS parameter is to be applied to at least one UE or UE group; the method further comprises sending the applied QoS parameter to a session management entity.

In an embodiment, the determining at least one internal subscribed QoS parameter further comprising: mapping the at least one QoS reference parameter to the at least one internal subscribed QoS parameter based on a mapping configuration.

In an embodiment, the second parameter provisioning request further includes an identifier of the application entity and an external group identifier.

In an embodiment, the method further comprises obtaining at least one original QoS parameter, wherein the at least one original QoS parameter is pre-configured for the at least one UE or UE group.

In an embodiment, the determining at least one applied QoS parameter further comprises selecting one from the at least one internal subscribed QoS parameter and the at least one original QoS parameter as the applied QoS parameter.

In an embodiment, the determining at least one applied QoS parameter further comprises: selecting the at least one internal subscribed QoS parameter as the applied QoS parameter.

In a fifth aspect of the disclosure, there is provided an apparatus at an exposure entity. The apparatus comprises a processor; and a memory coupled to the processor, said memory containing instructions executable by said processor, the apparatus is operative to receive a first parameter provisioning request from an application entity, wherein the first parameter provisioning request includes at least one Quality of Service, QoS reference parameter for at least one User Equipment, UE, or UE group; the apparatus is further operative to determine at least one internal subscribed QoS parameter based on the at least one QoS reference parameter; the apparatus is further operative to send a second parameter provisioning request to a data management entity, wherein the second parameter provisioning request includes the at least one internal subscribed QoS parameter.

In a sixth aspect of the disclosure, there is provided an apparatus at a network entity. The apparatus comprises a processor; and a memory coupled to the processor, said memory containing instructions executable by said processor, the apparatus is operative to receive a second parameter provisioning request from an exposure entity. wherein the second parameter provisioning request includes the at least one internal subscribed QoS parameter; the apparatus is further operative to determine at least one applied QoS parameter based on the at least one internal subscribed QoS parameter, wherein the applied QoS parameter is to be applied to at least one UE or UE group; the apparatus is further operative to send the applied QoS parameter to a session management entity.

In a seventh aspect of the disclosure, there is provided an apparatus at an application entity. The apparatus comprises a processor; and a memory coupled to the processor, said memory containing instructions executable by said processor, the apparatus is operative to obtain at least one Quality of Service, QoS reference parameter for at least one User Equipment, UE, or UE group; the apparatus is further operative to send a first parameter provisioning request to an exposure entity, wherein the first parameter provisioning request includes the at least one QoS reference parameter.

In an eighth aspect of the disclosure, there is provided an apparatus at a policy control entity. The apparatus comprises a processor; and a memory coupled to the processor, said memory containing instructions executable by said processor, the apparatus is operative to receive a second parameter provisioning request from an exposure entity, wherein the second parameter provisioning request includes the at least one Quality of Service, QoS reference parameter; the apparatus is further operative to determine at least one internal subscribed QoS parameter based on the at least one QoS reference parameter; the apparatus is further operative to determine at least one internal subscribed QoS parameter based on the at least one QoS reference parameter; the apparatus is further operative to send the applied QoS parameter to a session management entity.

In a ninth aspect of the disclosure, there is provided an apparatus at an exposure entity. The apparatus comprises a receiving unit configured to receive a first parameter provisioning request from an application entity, wherein the first parameter provisioning request includes at least one Quality of Service, QoS reference parameter for at least one User Equipment, UE, or UE group; the apparatus further comprises a determining unit configured to determine at least one internal subscribed QoS parameter based on the at least one QoS reference parameter; the apparatus further comprises a sending unit configured to send a second parameter provisioning request to a data management entity, wherein the second parameter provisioning request includes the at least one internal subscribed QoS parameter.

In a tenth aspect of the disclosure, there is provided an apparatus at a network entity. The apparatus comprises a receiving unit configured to receive a second parameter provisioning request from an exposure entity, wherein the second parameter provisioning request includes the at least one internal subscribed QoS parameter; the apparatus further comprises a determining unit configured to determine at least one applied QoS parameter based on the at least one internal subscribed QoS parameter, wherein the applied QoS parameter is to be applied to at least one UE or UE group; the apparatus further comprises a sending unit configured to send the applied QoS parameter to a session management entity.

In an eleventh aspect of the disclosure, there is provided an apparatus at an application entity. The apparatus comprises an obtaining unit configured to obtain at least one Quality of Service, QoS reference parameter for at least one User Equipment, UE, or UE group; the apparatus further comprises a sending unit configured to send a first parameter provisioning request to an exposure entity, wherein the first parameter provisioning request includes the at least one QoS reference parameter.

In a twelfth aspect of the disclosure, there is provided an apparatus at a policy control entity. The apparatus comprises a receiving unit configured to receive a second parameter provisioning request from an exposure entity, wherein the second parameter provisioning request includes the at least one Quality of Service, QoS reference parameter; the apparatus further comprises a determining unit configured to determine at least one internal subscribed QoS parameter based on the at least one QoS reference parameter; the apparatus further comprises a determining unit configured to determine at least one internal subscribed QoS parameter based on the at least one QoS reference parameter; the apparatus further comprises a sending unit configured to send the applied QoS parameter to a session management entity.

In thirteenth aspect of the disclosure, there is provided a computer-readable storage medium storing instructions which when executed by at least one processor, cause the at least one processor to perform the method according to any one of the first to the fourth aspect of the disclosure.

In fourteenth aspect of the disclosure, there is provided a computer program product, comprising instructions which, when executed on at least one processor, cause the at least one processor to carry out the method according to any one of the first to the fourth aspect of the disclosure.

The invention proposes a dynamic procedure to upgrade/uplift the QoS of a default bearer (default subscribed QoS for a PDU session). Many advantages may be achieved by applying the proposed solution according to embodiments of the present disclosure. By the mechanism in this invention, a third-party application (AF) to dynamically influence on the default QoS upgrade for a group of subscribers in a persistent way, i.e., even when the subscriber is not attached, or the device is rebooted, and the QoS may apply even if the subscriber is not attached.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows a high level architecture in the 5G network.

FIG. 2 shows a flowchart of a method at NEF according to one embodiment of the present disclosure.

FIG. 3 shows a flowchart of a method at a network entity like UDM or PCF according to one embodiment of the present disclosure.

FIG. 4 shows a flowchart of a method at an AF according to another embodiment of the present disclosure.

FIG. 5 shows a flowchart of a method at a PCF according to another embodiment of the present disclosure.

FIG. 6 shows a flowchart of a system method according one embodiment of the present disclosure.

FIG. 7 shows a flowchart of a system method according one embodiment of the present disclosure.

FIG. 8 shows a flowchart of a system method according one embodiment of the present disclosure.

FIG. 9 shows a block diagram showing an apparatus according to embodiments of the present disclosure.

FIG. 10 shows a block diagram showing an apparatus at NEF according to embodiments of the present disclosure.

FIG. 11 shows a block diagram showing an apparatus at a network entity like UDM or PCF according to embodiments of the present disclosure.

FIG. 12 shows a block diagram showing an apparatus at AF according to embodiments of the present disclosure.

FIG. 13 shows a block diagram showing an apparatus at PCF according to embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR). In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols as may comprise the 5G communication protocols, and/or any other protocols either currently known or to be developed in the future.

The term “entity” used herein refers to a network entity in a communication network. The “entity” can be implemented in a physical network node, or in a virtual network node which perform a function by logical resources in more than one physical network node. The “entity” can be implemented in a centralized way, or in a distributed way. The “entity” can also be implemented in the cloud.

The term “network function (NF)” refers to any suitable function which can be implemented in a network node (physical or virtual) of a communication network. For example, the 5G system (5GS) may comprise a plurality of NFs such as AMF, SMF, AUSF, UDM, PCF, AF, NEF, UPF and NRF, (R) AN, SCP, etc. In other embodiments, the network function may comprise different types of NFs for example depending on a specific type of network.

The terminal device may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UF” may be used interchangeably. As one example, a terminal device may represent a UF configured for communication in accordance with one or more communication standards promulgated by the 3GPP, such as 3GPP LTE standard or NR standard. a terminal device may be designed to transmit information to a network on a predetermined schedule, when triggered by an internal or external event, or in response to requests from the communication network.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar same meanings may also be used.

In the following description and claims, unless defined otherwise, all technical and scientific terms used herein have the same meaning as commonly understood by one of ordinary skills in the art to which this disclosure belongs.

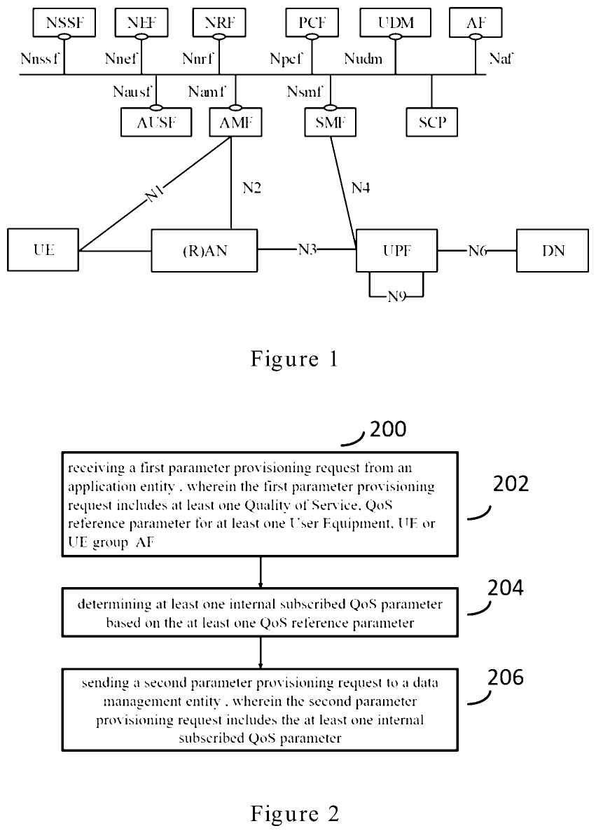

Although the subject matter described herein may be implemented in any appropriate type of system using any suitable components, the embodiments disclosed herein are described in relation to a communication system complied with the exemplary system architecture illustrated in FIG. 1. For simplicity, the system architecture of FIG. 1 only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

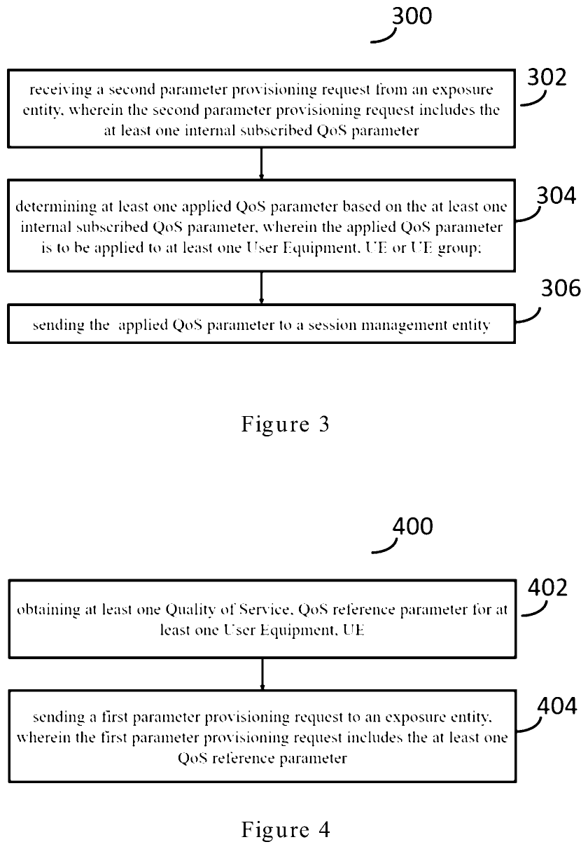

FIG. 4 shows flowcharts of methods 400 according to an embodiment of the present disclosure, which may be performed by an apparatus implemented in or at or as an application entity or communicatively coupled to the mobility management entity. As such, the apparatus may provide means or modules for accomplishing various parts of the method 400 as well as means or modules for accomplishing other processes in conjunction with other components.

At block 402, the application entity obtains at least one Quality of Service, QoS reference parameter for at least one UE or UE group. The application entity can be Application Function, AF, or a Service Capability Server (SCS)/Application Server (AS).

The application entity can obtain the QOS reference parameter in various ways. In the first embodiment, the QOS reference parameters can be configured manually by the operator in the AF. For example, the operator decides to make influence on the QoS upgrade for a group of subscribers, the operator can configure the AF with the QoS reference parameter for a specific group of UE, which can be identified by external identifier. In the second embodiment, the AF can receive the QoS reference parameters from another network node.

The QoS reference parameter new parameter to be added over the NEF Parameter Provisioning API, it is a pre-defined QoS information which can be identified by the third party (AF). The QoS reference parameter can be the same String format as “QoSReference” as defined in 3GPP TS 29.122 V17.5.0 for NEF/SCEF AsSession WithQOS API.

At block 404, the application entity sends a first parameter provisioning request to an exposure entity, wherein the first parameter provisioning request includes the at least one QoS reference parameter. The exposure entity can be Network Exposure Function, NEF in 5G network, or a Service Capability Exposure Function, SCEF in 4G network.

In an embodiment, before the block 402, the application entity may determine that the at least one QoS reference parameter for at least one UE or UE group needs to be changed. For example, the operator decides to update QoS parameters for a group of subscribers, the operator can configure the AF with the updated QoS reference parameter for a specific group of UE. And then, the application entity includes the updated QoS reference parameter into the first parameter provisioning request and sends it to the NEF.

FIG. 2 shows flowcharts of methods 200 according to an embodiment of the present disclosure, which may be performed by an apparatus implemented in or at or as an exposure entity or communicatively coupled to the mobility management entity. As such, the apparatus may provide means or modules for accomplishing various parts of the method 200 as well as means or modules for accomplishing other processes in conjunction with other components.

At block 202, the exposure entity receives a first parameter provisioning request from an application entity, wherein the first parameter provisioning request includes at least one QoS reference parameter for at least one User Equipment, UE or UE group. The exposure entity can be a NEF in 5G network, or a SCEF in 4G network.

The first parameter provisioning request may further include an identifier of the application entity (e.g., AF ID), and or a UE identifier or an external group identifier (e.g., External Group ID).

In an embodiment, the first parameter provisioning request is a Parameter Provisioning create message which includes the following parameters: External Group ID, AF ID, and QoS reference parameter.

At block 204, the exposure entity determines at least one internal subscribed QoS parameter based on the at least one QoS reference parameter. The NEF can map the QoS reference parameter to the internal subscribed QoS parameter based on a pre-configured mapping index. The internal subscribed QoS parameter is the QoS parameter that can be identified internally by the UDM, UDR, PCF or other internal core network entities. In an example, the internal subscribed QoS parameter comprises 5G QOS Identifier (5Q1)/QoS Class Identifier (QCI) and the ARP (Allocation and Retention Priority), and optionally the internal subscribed QoS parameter further comprises PriorityLevel and or Reflective QoS Attribute (RQA), etc.

The 5QI is used in 3GPP to identify a specific QoS forwarding behavior for a 5G QoS Flow (similar to the QCI value used for LTE). As such, it defines packet loss rate, packet delay budget etc. The RQA is an optional parameter which indicates that certain traffic (not necessarily all) carried on this QoS Flow is subject to Reflective QoS. The PriorityLevel defines the 5Q1 Priority Level, when present, it contains the 5QI Priority Level value that overrides the standardized or pre-configured values as described in 3G U.S. Plant Pat. No. 23,501 clause 5.7.2.7. ARP contains information about the priority level, the pre-emption capability and the pre-emption vulnerability.

In an embodiment, the NEF may also determine at least one Protocol Data Unit, PDU session in which the QoS reference parameter to be applied at least based on the identifier of the application entity and the external group identifier. For example, the NEF determines the DNN/S-NSSAI (Data Network Name/Single Network Slice Selection Assistance information) which is used to identify the specific PDU session based on the AF ID and the External Group ID included in the first parameter provisioning request.

NEF can make the mapping using the local configuration. The local configuration stores the mapping relationship between the QoS reference parameters and the internal subscribed QoS parameters, and also stores the mapping relationship between the AF ID/External Group ID and the DNN/S-NSSAI. After the mapping, the NEF can get the information of internal subscribed QOS parameter and which PDU session is to be applied.

At block 206, the exposure entity sends a second parameter provisioning request to a data management entity, wherein the second parameter provisioning request includes the at least one internal subscribed QOS parameter. The data management entity Unified Data Management, UDM.

In an embodiment, the second parameter provisioning request is Nudm Parameter Provisioning Create message including the following parameters: External Group ID, AF ID, internal subscribed QoS parameters (5QI, ARP), S-NSSAI, DNN.

FIG. 3 shows flowcharts of methods 300 according to an embodiment of the present disclosure, which may be performed by an apparatus implemented in or at or as an or communicatively coupled to the network entity. As such, the apparatus may provide means or modules for accomplishing various parts of the method 300 as well as means or modules for accomplishing other processes in conjunction with other components.

At block 302, the network entity receives a second parameter provisioning request from an exposure entity, wherein the second parameter provisioning request includes the at least one internal subscribed QoS parameter. The network entity is a Unified Data Management, UDM or a Policy Control Function, PCF.

In an embodiment, the second parameter provisioning request is Nudm Parameter Provisioning Create message including the following parameters: External Group ID, AF ID, internal subscribed QoS parameters (5QI, ARP), S-NSSAI, DNN.

In an embodiment, after receiving the second parameter provisioning request, the UDM determines whether the application entity is authorized to provision parameter for the UE. In an example, the UDM checks the AF ID included in the second parameter provisioning request to see whether it is in the allowed list, if yes, UDM allows the received AF ID to set the QoS parameters for the received External ID and UDM stores the internal subscribed QoS parameter in the UDR.

In an embodiment, the UDM obtains at least one original QoS parameter, wherein the at least one original QoS parameter is pre-configured for the at least one UE or UE group. When the UE establishes a new PDU session, the original QoS parameters (manually provisioned QOS parameters, which applies for the existing PDU session after the PDU session is established and only valid for the lifetime of the PDU session) may be provided to the UDM (according to the method in 3GPP TS 23.502 V17.4.0 clause 4.15.6.6).

At block 304, the network entity determines at least one applied QoS parameter based on the at least one internal subscribed QOS parameter, wherein the applied QoS parameter is to be applied to at least one User Equipment, UE or UE group.

The network entity may determine the applied QoS parameter in various ways. In one example, UDM selects the internal subscribed QoS parameter as the applied QoS parameter, ignoring the manually provisioned QoS parameters. In another example, UDM chooses one from the internal subscribed QoS parameter and the manually provisioned QoS parameter, and determines the internal subscribed QoS parameter as the applied QoS parameter based on the pre-configuration, for example the priority of the internal subscribed QoS parameter is higher than the manually provisioned QoS parameters. Then, UDM replaces the manually provisioned QoS parameters with the internal subscribed QoS parameter as the applied QoS parameter for the UE for the PDU session which is identified by the DNN/S-NSSAI. In this embodiment, UDM gives precedence to the AF-provided QoS profile against the manually provided QoS profile.

In an embodiment, the UDM further check whether there is at least one PDU session ongoing for the at least one UE, in another embodiment, the UDM may further check whether the UE belongs to the affected group. If there is an ongoing PDU session and the UE belongs to the affected group, the UDM sends the applied QoS parameter to the session management entity, so that the at least one internal subscribed QoS parameter can take effect immediately.

At block 306, the network entity sends the applied QoS parameter to a session management entity. The session management entity is a Session Management Function, SMF. After receiving the applied QoS parameter, SMF applies the QoS parameter to the PDU session.

According to the above solution 1, the UDM has the privilege to determine which QoS parameter to be applied to the PDU session. By the mechanism in this invention, a third-party application (AF) to dynamically influence on the default QoS upgrade for a group of subscribers in a persistent way, i.e., even when the subscriber is not attached, or the device is rebooted, and the QoS may apply even if the subscriber is not attached.

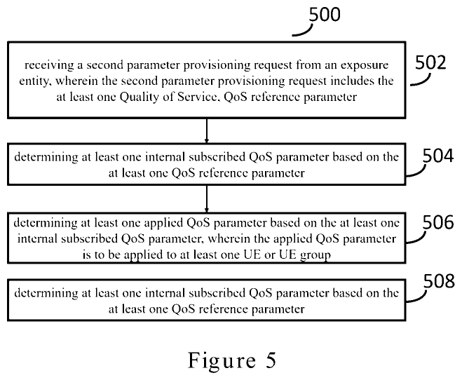

FIG. 5 shows flowcharts of methods 500 according to an embodiment of the present disclosure, which may be performed by an apparatus implemented in or at or as an or communicatively coupled to the policy control entity. As such, the apparatus may provide means or modules for accomplishing various parts of the method 500 as well as means or modules for accomplishing other processes in conjunction with other components.

At block 502, the policy control entity receives a second parameter provisioning request from an exposure entity, wherein the second parameter provisioning request includes the at least one Quality of Service, QoS reference parameter. The policy control entity comprises Policy Control Function, PCF. The exposure entity comprises a NEF.

Before the block 502, the NEF receives a first parameter provisioning request from an application entity, wherein the first parameter provisioning request includes QoS reference parameter. After receiving the QoS reference parameter, the NEF forwards the QoS reference parameter included in the second parameter provisioning request to the PCF. NEF doesn't make the mapping as the FIG. 2 shows, NEF just forward the QoS reference parameter.

At block 504, the policy control entity determines at least one internal subscribed QoS parameter based on the at least one QoS reference parameter. After receiving the second parameter provisioning request from the NEF, PCF can map the QoS reference parameter to the internal subscribed QoS parameter based on a pre-configured mapping index. The internal subscribed QoS parameter is the QoS parameter that can be identified internally by the UDM, UDR, PCF or other internal core network entities. In an example, the internal subscribed QoS parameter comprises 5G QoS Identifier (5Q1)/QoS Class Identifier (QCI) and the ARP (Allocation and Retention Priority), and optionally the internal subscribed QoS parameter further comprises PriorityLevel and or Reflective QoS Attribute (RQA), etc.

In an embodiment, the PCF may also determine at least one Protocol Data Unit, PDU session in which the QoS reference parameter to be applied at least based on the identifier of the application entity and the external group identifier. For example, the PCF determines the DNN/S-NSSAI (Data Network Name/Single Network Slice Selection Assistance information) which is used to identify the specific PDU session based on the AF ID and the External Group ID included in the first parameter provisioning request.

PCF can make the mapping using the local configuration. The local configuration stores the mapping relationship between the QoS reference parameters and the internal subscribed QoS parameters, and also stores the mapping relationship between the AF ID/External Group ID and the DNN/S-NSSAI. After the mapping, the PCF can get the information of internal subscribed QoS parameter and which PDU session is to be applied.

In an embodiment, the PCF obtains at least one original QoS parameter, wherein the at least one original QoS parameter is pre-configured for the at least one UE or UE group. When the UE establishes a new PDU session, the original QoS parameters (manually provisioned QoS parameters, which applies for the existing PDU session after the PDU session is established and only valid for the lifetime of the PDU session, according to the method in 3GPP TS 23.502 V17.4.0 clause 4.15.6.6) may be provided to the PCF.

At block 506, the policy control entity determines at least one applied QoS parameter based on the at least one internal subscribed QoS parameter, wherein the applied QoS parameter is to be applied to at least one UE or UE group.

The policy control entity may determine the applied QoS parameter in various ways. In one example, PCF selects the internal subscribed QoS parameter as the applied QoS parameter, ignoring the manually provisioned QoS parameters. In another example, UDM chooses one from the internal subscribed QoS parameter and the manually provisioned QoS parameter, and determines the internal subscribed QoS parameter as the applied QoS parameter based on the pre-configuration, for example the priority of the internal subscribed QoS parameter is higher than the manually provisioned QoS parameters. Then, PCF replaces the manually provisioned QoS parameters with the internal subscribed QoS parameter as the applied QoS parameter for the UE for the PDU session which is identified by the DNN/S-NSSAI. In this embodiment, PCF gives precedence to the AF-provided QoS profile against the manually provided QoS profile.

At block 508, the policy control entity sends the applied QoS parameter to a session management entity. The session management entity is a Session Management Function, SMF. After receiving the applied QoS parameter, SMF applies the QoS parameter to the PDU session.

According to the above solution 2, the PCF has the privilege to determine which QoS parameter to be applied to the PDU session. By the mechanism in this invention, a third-party application (AF) to dynamically influence on the default QoS upgrade for a group of subscribers in a persistent way, i.e., even when the subscriber is not attached, or the device is rebooted, and the QoS may apply even if the subscriber is not attached.

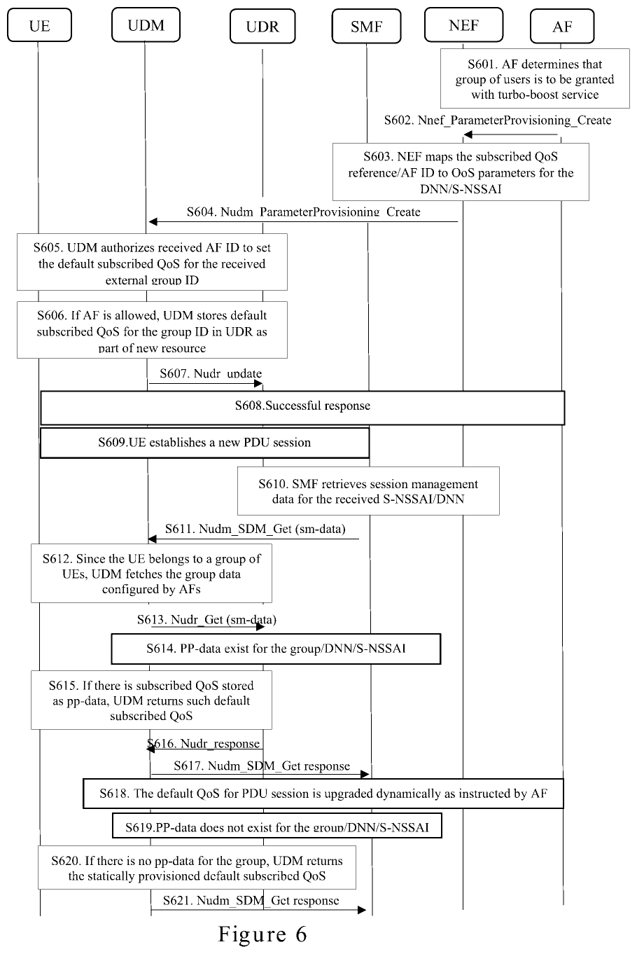

FIG. 6 shows a flowchart of a system method according one embodiment of the present disclosure in which the Parameter Provisioning is made when UE is not registered.

S601. Application Function detects a trigger condition for a group of users to be upgraded their QoS temporarily.

S602. AF invokes Parameter Provisioning by sending Nnef_ParameterProvisioning_Create message including External Group ID, new added QoS reference parameter, AF ID to the NEF.

S603. NEF uses new local configuration to map the QoS reference received and the AF ID/MTC Provided ID into subscribed QoS parameters for a DNN/S-NSSAI (also mapped/derived from the AF request based on the AF/Application).

The QoSReference is new parameter to be added over the NEF Parameter Provisioning API, which can be the same String format as QoSReference parameter as defined in 3GPP TS 29.122 for NEF SCEF AsSession WithQOS API. Similar as the QOS API, a Local SLA Policy should be defined in the NEF per Application/AF to map the QoSReference provided by AF/AS to internal subscribed QoS Parameters, e.g., 5QI/QCI, ARP, PriorityLevel etc. this mapping is pre-provisioned within the NEF/SCEF by operator after mapping to internal subscribedDefaultQoS parameter, NEF will include this new parameter in the CommunicationCharacteristicsAF for Nudm_PP Service as showing below (3GPP TS 29.503 V17.6.0 Clause 6.5.6.2.20):

TABLE 6.5.6.2.20-1
Definition of type CommunicationCharacteristicsAF

| Attribute name | Data type | P | Cardinality | Description |
|---|---|---|---|---|
| ppDIPacketCount | PpDIPacketCount | O | 0 . . . 1 | AF provisioned DL Buffering Suggested Packet |
| | | | | Count; nullable |
| maximumResponseTime | DurationSec | O | 0 . . . 1 | When present, this IE shall contain value of |
| | | | | Maximum Response Time in seconds. |
| | | | | Maximum Response Time identifies the time for |
| | | | | which the UE stays reachable to allow the AF to |
| | | | | reliably deliver the required downlink data, see |
| | | | | clause 4.15.6.3a of 3GPP TS 23.502 [3]. |
| maximumLatency | DurationSec | O | 0 . . . 1 | When present, this IE shall contain value of |
| | | | | Maximum Latency in seconds. |
| | | | | Maximum Latency identifies maximum delay |
| | | | | acceptable for downlink data transfers, see |
| | | | | clause 4.15.6.3a of 3GPP TS 23.502 [3]. |
| 5gQoSProfile | SubscribedDefaultQoS | O | 0 . . . 1 | 5G QoS parameters associated to the |
| | | | | session for a data network |

S604. NEF sends the Nudm_ParameterProvisioning_Create message to UDM with the new mapped parameters. The Nudm_ParameterProvisioning_Create message includes External Group ID, AF ID, internal subscribed QoS parameters (5QI, ARP), S-NSSAI, DNN.

S605. UDM authorizes received AF ID to set the default subscribed QoS for the received external group ID.UDM fetches from UDR the list of MTC Providers/AFs which are allowed to influence/modify the subscribed QoS via Parameter Provisioning. This list is new provisioned data for the External Group Identifier. The data is stored in UDR.

S606. If the AF is allowed, UDM stores the QoS data received from NEF in a new resource for parameter provisioning data for the group.

S607. UDM sends the Nudr_update message including the Group ID, S-NSSAI, DNN, 5QI, ARP, AF ID to the UDR.

S608. Successful response is sent from UDM to NEF.

S609. The UE establishes a new PDU session to the SMF.

S610-S611, SMF fetches the SM-data for the requested DNN/S-NSSAI associated to the PDU session by sending the Nudm_SDM_Get message to the UDM.

S612-S613. UDM fetches the group data configured by Afs since the UE belongs to the group by sending the Nudr_Get message to the UDR.

S614-S616. If there is QoS data (as stored in step 7), UDR returns the QoS data to UDM.

S617. UDM replaces the manually provisioned SM-data for the UE for the DNN/S-NSSAI and instead provides the SMF with the retrieved QoS in the Parameter Provisioning data-set for the related DNN/S-NSSAI.

S618. The QoS is upgraded for the UE when compared to the manually provisioned data due to AF new parameter provisioning data.

S619-S621. If there is no QoS data for the group (e.g., 404 not found error returned by UDR in step 16), UDM returns the manually provisioned QoS as part of SM data.

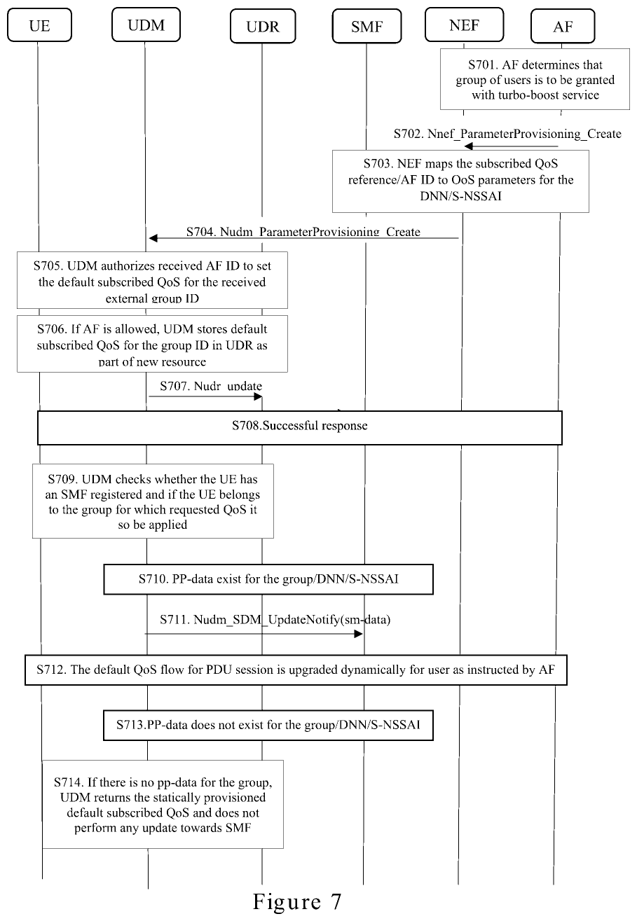

FIG. 7 shows a flowchart of a system method according one embodiment of the present disclosure in which Parameter Provisioning has an ongoing PDU session. S701 S708 are the same as S601-608 in FIG. 6.

S709, after storing the group data, UDM checks the UEs affected by the new group data. For each of them, UDM checks whether the UE has an ongoing PDU session (i.e., there is an SMF registered) and whether the UE belongs to the affected group.

S710 S712. UDM updates the SM data in the related SMF so that the QoS information takes effect immediately.

S713-S714. If the QoS is not to be applied to the UE (e.g., the UE belongs to a different group of UEs that the one created updated), UDM keeps the current QoS profile and does not inform SMF.

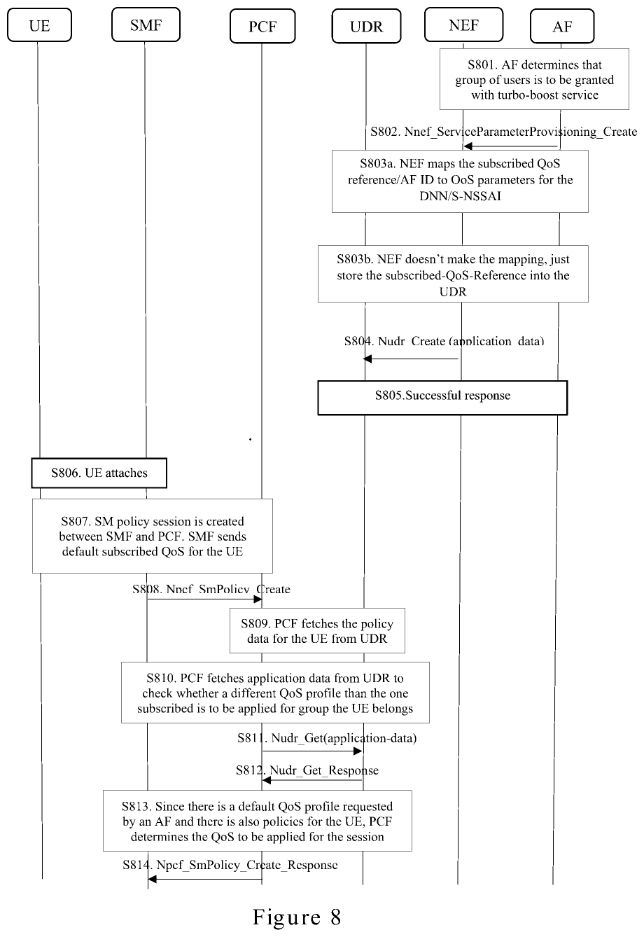

FIG. 8 below shows another alternative based on enhancing the Service Parameter in NEF (instead of the Parameter Provisioning depicted in FIG. 6-7). This approach stores the new data directly in UDR, as part of application-data, and PCF will make use of the application-data with the AF Provided QoS Profile to derive the QoS Parameters and generate the PCC rules for the UE(s). NEF can decide, based on local policy on a per AS basis, whether to use Solution 1 or Solution 2. Solution 1 (corresponding FIG. 6-7) respects the ownership of the subscribed QoS (UDM as owner), avoid inconsistencies, and avoids impacts in PCF since it is the UDM the one to decide which subscribed QoS should be effective for each UE group member. Solution 1 though does not allow PCF to be aware of both the subscribed QoS and the AF requested QoS, in order to take such information into account when evaluating policies. This is only possible with Solution 2. Therefore, it depends on the type of AS and the type of UE policies to decide which solution is to be applied on each case. Besides solution 2 allows to derive additional QoS characteristics associated to the Default QoS handling considering AF demands that are not part of the subscription data in the UDM (averaging window, maximum data burst volume, MBR, GBR).

S801. Application Function detects a trigger condition for a group of users to be upgraded their QoS temporarily.

S802. AF invokes Parameter Provisioning by sending Nnef ServiceParameterProvisioning_Create message including External Group ID, new added QoS reference parameter, AF ID to the NEF.

After receiving the Nnef_ServiceParameterProvisioning_Create message, there are two alternatives. The first option is NEF maps the subscribed QoS reference/AF ID to OoS parameters for the DNN/S-NSSAI as shown in S803a-804a. The second option is NEF can directly store the subscribed-QoS-Reference into the UDR, so that NEF can skip the mapping of the QOS reference to QoS Parameters (ARP/5QI etc.), and PCF will translate to the QoS Parameters based on its local policy when it reads the data from UDR.

S804-S805. NEF stores the QoS for the group as new application data resource (e.g., application-data/default-QoS). These data are stored in the UDR.

S806. UE attaches.

S807-S808. SM policy session is created between SMF and PCF. SMF sends default subscribed QoS for the UE.

S809. PCF fetches the policy data for the UE from UDR.

S810-S812, PCF fetches application data from UDR (by sending Nudr_Get (application-data) message to UDR and receiving Nudr_Get_Response message from the UDR). PCF checks whether a different QoS profile than the one subscribed is to be applied for group the UE belongs. In this step, if the application data includes the original subscribed QoS reference/AF ID which is not mapped by the NEF, the PCF will map the subscribed QoS reference to QoS Parameters (ARP/5QI etc.). If the application data includes QoS Parameters (ARP/5QI etc.) which is mapped by NEF in step 803, PCF will not make the mapping.

S813. Since QoS data is found in the application data for the requested group, UDR returns the QoS data.

S814. Since PCF now has the subscribed QoS and the AF-requested QoS (as received in previous step), PCF determines that the QoS to be applied for the session is the one requested by AF (i.e., one in application data for the group, not in policy data for the UE).

S817. The upgraded QoS is returned to SMF so that it is applied for the PDU session for the UE group member.

FIG. 9 is a block diagram showing an apparatus suitable for use in practicing some embodiments of the disclosure. For example, any one of the or above may be implemented through the apparatus 900.

The apparatus 900 comprises at least one processor 921, such as a DP, and at least one MEM 922 coupled to the processor 921. The apparatus 900 may further comprise a transmitter TX and receiver RX 923 coupled to the processor 921. The MEM 922 stores a PROG 924. The PROG 924 may include instructions that, when executed on the associated processor 921, enable the apparatus 920 to operate in accordance with the method at the mobility management entity or with the method at the terminal device. A combination of the at least one processor 921 and the at least one MEM 922 may form processing means 925 adapted to implement the method at the mobility management entity or with the method at the terminal device as shown above.

Various embodiments of the present disclosure may be implemented by computer program executable by one or more of the processor 921, software, firmware, hardware or in a combination thereof.

The MEM 922 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 921 may be of any type suitable to the local technical environment, and may include one or more of general purpose computers, special purpose computers, microprocessors, digital signal processors DSPs and processors based on multicore processor architecture, as non-limiting examples.

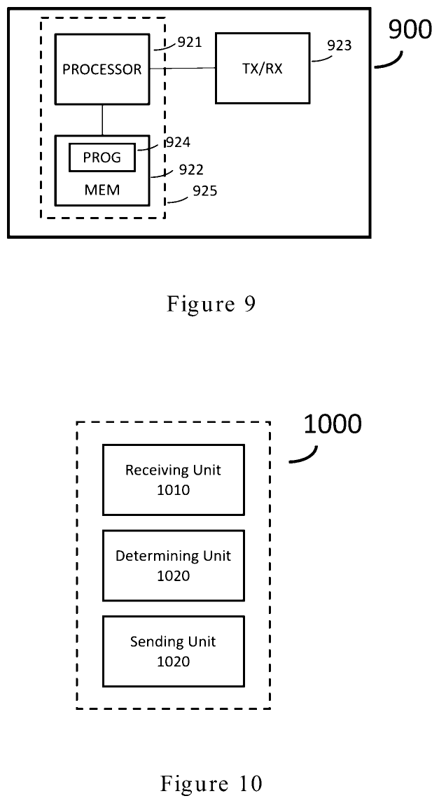

Correspondingly to the method 200 as described above, an exposure entity is provided. FIG. 10 is a block diagram of an exposure entity 1000 according to an embodiment of the present disclosure.

The exposure entity 1000 is operative to perform the method 200 as described above in connection with FIG. 2 The exposure entity 1000 includes receiving unit (1010) configured to receive a first parameter provisioning request from an application entity, wherein the first parameter provisioning request includes at least one Quality of Service, QoS reference parameter for at least one User Equipment, UE, or UE group; the apparatus further comprises a determining unit (1020) configured to determine at least one internal subscribed QoS parameter based on the at least one QoS reference parameter; the apparatus further comprises a sending unit (1030) configured to send a second parameter provisioning request to a data management entity, wherein the second parameter provisioning request includes the at least one internal subscribed QoS parameter.

The units 1010, 1020 and 1030 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 2.

Correspondingly to the method 300 as described above, a network entity is provided. FIG. 11 is a block diagram of a network entity 1100 according to an embodiment of the present disclosure.

The network entity 1100 is operative to perform the method 300 as described above in connection with FIG. 3 The network entity 1100 includes a receiving unit 1110 configured to receive a second parameter provisioning request from an exposure entity, wherein the second parameter provisioning request includes the at least one internal subscribed QoS parameter; the apparatus further comprises a determining unit 1120 configured to determine at least one applied QoS parameter based on the at least one internal subscribed QoS parameter, wherein the applied QoS parameter is to be applied to at least one UE or UE group; the apparatus further comprises a sending unit 1130 configured to send the applied QoS parameter to a session management entity.

The units 1110, 1120 and 1130 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 3.

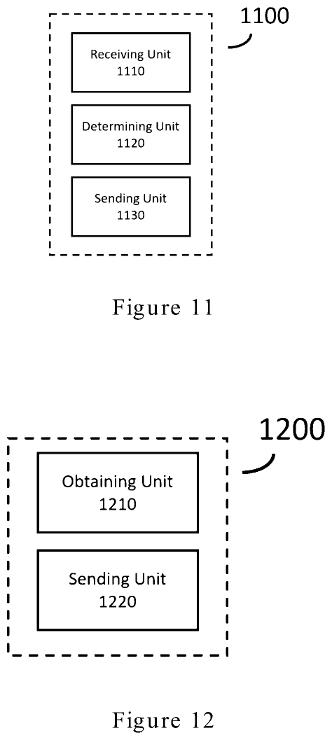

Correspondingly to the method 400 as described above, an application entity is provided. FIG. 12 is a block diagram of an application entity 1200 according to an embodiment of the present disclosure.

The application entity 1200 is operative to perform the method 400 as described above in connection with FIG. 4 The application entity 1200 includes an obtaining unit 1210 configured to obtain at least one Quality of Service, QoS reference parameter for at least one User Equipment, UE, or UE group; the apparatus further comprises a sending unit 1220 configured to send a first parameter provisioning request to an exposure entity, wherein the first parameter provisioning request includes the at least one QoS reference parameter.

The units 1210 and 1220 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4.

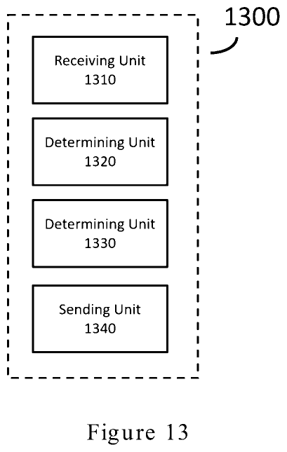

Correspondingly to the method 500 as described above, a policy control entity is provided. FIG. 13 is a block diagram of a policy control entity300 according to an embodiment of the present disclosure.

The policy control entity 1300 is operative to perform the method 500 as described above in connection with FIG. 5 The policy control entity 1300 includes a receiving unit 1310 configured to receive a second parameter provisioning request from an exposure entity, wherein the second parameter provisioning request includes the at least one Quality of Service, QoS reference parameter; the apparatus further comprises a determining unit 1320 configured to determine at least one internal subscribed QoS parameter based on the at least one QoS reference parameter; the apparatus further comprises a determining unit 1330 configured to determine at least one internal subscribed QoS parameter based on the at least one QoS reference parameter; the apparatus further comprises a sending unit 1340 configured to send the applied QoS parameter to a session management entity.

The units 1310,1320, 1330 and 1340 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5.

According to an aspect of the disclosure it is provided a computer program product being tangibly stored on a computer readable storage medium and including instructions which, when executed on at least one processor, cause the at least one processor to carry out any of the methods related to the exposure entity as described above.

According to an aspect of the disclosure it is provided a computer program product being tangibly stored on a computer readable storage medium and including instructions which, when executed on at least one processor, cause the at least one processor to carry out any of the methods related to the application entity as described above.

According to an aspect of the disclosure it is provided a computer program product being tangibly stored on a computer readable storage medium and including instructions which, when executed on at least one processor, cause the at least one processor to carry out any of the methods related to the network entity as described above.

According to an aspect of the disclosure it is provided a computer program product being tangibly stored on a computer readable storage medium and including instructions which, when executed on at least one processor, cause the at least one processor to carry out any of the methods related to the policy control entity as described above.

According to an aspect of the disclosure it is provided a computer-readable storage medium storing instructions which when executed by at least one processor, cause the at least one processor to carry out any of the methods related to the exposure entity as described above.

According to an aspect of the disclosure it is provided a computer-readable storage medium storing instructions which when executed by at least one processor, cause the at least one processor to carry out any of the methods related to the application entity as described above.

According to an aspect of the disclosure it is provided a computer-readable storage medium storing instructions which when executed by at least one processor, cause the at least one processor to carry out any of the methods related to the network entity as described above.

According to an aspect of the disclosure it is provided a computer-readable storage medium storing instructions which when executed by at least one processor, cause the at least one processor to carry out any of the methods related to the policy control entity as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-39. (canceled)

40. A method in an exposure entity, the method comprising:
receiving a first parameter provisioning request from an application entity, wherein the first parameter provisioning request includes at least one Quality of Service (QOS) reference parameter for at least one User Equipment (UE) or UE group;
determining at least one internal subscribed QoS parameter based on the at least one QoS reference parameter; and
sending a second parameter provisioning request to a data management entity, wherein the second parameter provisioning request includes the at least one internal subscribed QoS parameter.

41. The method according to claim 40, wherein the determining at least one internal subscribed QoS parameter further comprising mapping the at least one QoS reference parameter to the at least one internal subscribed QoS parameter, based on a mapping configuration.

42. The method according to claim 40, wherein the first and the second parameter provisioning request further includes an identifier of the application entity and a UE identifier or an external group identifier, and wherein the method further comprises determining at least one Protocol Data Unit (PDU) session in which the QoS reference parameter to be applied at least based on the identifier of the application entity.

43. The method according to claim 40, wherein the internal subscribed QoS parameter comprises at least one of the following:
a 5G QoS Identifier (5QI)/QoS Class Identifier (QCI);
an Allocation and Retention Priority (ARP); or
a PriorityLevel.

44. The method according to claim 40, wherein the exposure entity comprises a Network Exposure Function (NEF) or a Service Capability Exposure Function (SCEF), wherein the application entity comprises an Application Function (AF) or a Service Capability Server (SCS)/Application Server (AS), and wherein the data management entity comprises a Unified Data Management (UDM) or a Home Subscriber Server (HSS).

45. A method in a network entity, the method comprising:
receiving a second parameter provisioning request from an exposure entity, wherein the second parameter provisioning request includes the at least one internal subscribed Quality of Service (QOS) parameter;
determining at least one applied QoS parameter, based on the at least one internal subscribed QoS parameter, wherein the at least one applied QoS parameter is to be applied to at least one User Equipment (UE) or UE group;
sending the at least one applied QoS parameter to a session management entity.

46. The method according to claim 45, wherein the second parameter provisioning request further includes an identifier of the application entity, and a UE identifier or an external group identifier.

47. The method according to claim 46, further comprising storing the at least one internal subscribed QoS parameter, responsive to determining, based on the identifier of the application entity, that the application entity is authorized to provision parameters for the UE.

48. The method according to claim 45, further comprising:
obtaining at least one original QoS parameter, wherein the at least one original QoS parameter is pre-configured for the at least one UE or UE group; and
wherein the determining at least one applied QoS parameter comprises selecting one from the at least one internal subscribed QoS parameter and the at least one original QoS parameter as the applied QoS parameter.

49. The method according to claim 48, wherein the determining at least one applied QoS parameter further comprises selecting the at least one internal subscribed QoS parameter as the at least one applied QoS parameter.

50. The method according to claim 48, wherein the determining at least one applied QoS parameter based on the at least one internal subscribed QoS parameter comprises using the at least one internal subscribed QoS parameter as the at least one applied QoS parameter.

51. The method according to claim 48, further comprising determining that there is at least one PDU session ongoing for the at least one UE or UE group and, in response, sending the at least one applied QoS parameter to the session management entity, so that the at least one internal subscribed QoS parameter takes effect immediately.

52. The method according to claim 48, wherein the network entity comprises a Unified Data Management (UDM), or a Home Subscriber Server (HSS) or a Policy Control Function (PCF), or a Unified Data Repository (UDR), wherein the exposure entity comprises a Network Exposure Function (NEF), or a Service Capability Exposure Function (SCEF), wherein the application entity comprises an Application Function (AF), or a Service Capability Server (SCS)/Application Server (AS), and wherein the session management entity comprises a Session Management Function (SMF).

53. A method in an application entity, the method comprising:
obtaining at least one Quality of Service (QOS) reference parameter for at least one User Equipment (UE) or UE group; and
sending a first parameter provisioning request to an exposure entity, wherein the first parameter provisioning request includes the at least one QoS reference parameter.

54. A method in a policy control entity, the method comprising:
receiving a second parameter provisioning request from an exposure entity, wherein the second parameter provisioning request includes the at least one Quality of Service (QoS) reference parameter;
determining at least one internal subscribed QoS parameter based on the at least one QoS reference parameter;
determining at least one applied QoS parameter, based on the at least one internal subscribed QoS parameter, wherein the at least one applied QoS parameter is to be applied to at least one UE or UE group; and
sending the applied QoS parameter to a session management entity.

55. An exposure entity, the exposure entity comprising:
a processor; and
a memory coupled to the processor, said memory containing instructions executable by said processor, whereby said first mobile management node is operative to:
receive a first parameter provisioning request from an application entity, wherein the first parameter provisioning request includes at least one Quality of Service, QoS reference parameter for at least one User Equipment, UE, or UE group;
determine at least one internal subscribed QoS parameter based on the at least one QoS reference parameter;
send a second parameter provisioning request to a data management entity, wherein the second parameter provisioning request includes the at least one internal subscribed QoS parameter.

56. A network entity, the network entity comprising:
a processor; and
a memory coupled to the processor, said memory containing instructions executable by said processor, whereby said network entity is operative to:
receive a second parameter provisioning request from an exposure entity, wherein the second parameter provisioning request includes the at least one internal subscribed Quality of Service (QOS) parameter;
determine at least one applied QoS parameter, based on the at least one internal subscribed QoS parameter, wherein the at least one applied QoS parameter is to be applied to at least one User Equipment (UE) or UE group; and
send the applied QoS parameter to a session management entity.
